(19) United States
(12) Patent Application Publication
(10) Pub. No.: US 2005/0057252 A1
(43) Pub. Date: Mar. 17, 2005

(54) Method of detecting an ignition voltage signal using a pencil ignition coil and preferred use thereof

(75) Inventor: Robert Heislbetz, Steinheim (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 10/739,280

(22) Filed: Dec. 19, 2003

(30) Foreign Application Priority Data
Sep. 12, 2003 (DE) 103 42 533.0

(51) Int. Cl. F02P 17/00

(52) U.S. Cl. 324/380

(57) ABSTRACT

A method in which the electromagnetic radiation emitted by the pencil ignition system is detected capacitively and analyzed to yield an ignition voltage signal. Preferably, it is the radiation emitted by an ignition coil in the pencil ignition system that is detected capacitively and analyzed. The radiation is especially advantageously detected radially around the ignition coil. This permits detection of a measurement signal having a high amplitude and high quality. An associated pencil ignition system has a pencil-shaped arrangement of a spark plug (1) mounted on a neck piece (3) with an integrated ignition coil (23), and a measurement arrangement for an ignition voltage signal having a pickup (31) which at least partially surrounds the ignition coil (23) and is made of an electrically conducting material. The pencil ignition system preferably further includes a head part (4) with a connector plug (42) for external control signal lines and power supply lines, as well as a measurement signal line (41) for the ignition voltage signal extending from the pickup (31) to the connector plug (42). The ignition voltage signal can thereby be relayed, e.g., to an electronic analyzer, without the need for any additional cabling, by relaying the signal, e.g. over a cable harness electrically connected to the connector plug, e.g., by way of a mating plug.

The following disclosure is based on German Patent Application No. 10342533.0, filed on Sep. 12, 2003, which is incorporated into this application by reference.

### FIELD OF AND BACKGROUND OF THE INVENTION

The present invention relates to a method of detecting an ignition voltage signal generated by a pencil ignition coil and preferred embodiments for a pencil ignition coil having a corresponding design. This invention also relates to a preferred use of such a pencil ignition coil.

Conventional ignition systems, used for internal combustion engines in particular, have a central ignition coil and a distributor. For transmission of the ignition voltages created by this system for the spark plugs of the individual cylinders, there are ignition cables leading to the respective spark plugs. Such an ignition system offers a variety of possibilities for picking up signals, e.g., with the help of measurement tongs, so-called ignition harnesses and/or via plates mounted on the head of the ignition coil, for example, and sending them to an electronic analyzer. It is possible in this way to check on the height and shape of the ignition voltage for a spark plug and/or to check on the functionality of the entire ignition system.

So-called pencil ignition coils are used with the newer systems. This makes a so-called coil-per-cylinder (CPC) ignition possible. Thus, not just a spark plug is provided for each cylinder of an internal combustion engine; rather, each spark plug also has a separate, respective ignition coil. The spark plug and the ignition coil are arranged in the form of a pencil-shaped rod and often have an additional head part, into which an electronic unit for triggering the ignition coil may be integrated. In addition, a connector plug may also be provided there for control signal lines and power supply lines. With such an arrangement, the spark plug and ignition coil are connected directly together, thereby eliminating the need for complex cabling, which is disadvantageous from the standpoint of transmission of high voltages. However, there is the disadvantage that the lack of cabling does not allow ignition voltage signals to be picked up for diagnostic and service purposes. In addition, another disadvantage with respect to detecting ignition voltage signals is that access to such pencil ignition systems is difficult, e.g. in newer engine designs and in particular in engines having a large number of cylinders.

### OBJECTS OF THE INVENTION

One object of this invention is to provide a method with which it is possible to detect an ignition voltage signal even with respect to a pencil ignition system. This invention is additionally based on an object of further refining known pencil ignition systems so that it is possible to pick up an ignition voltage signal therefrom.

### SUMMARY OF THE INVENTION

These and other objects are achieved, according to one formulation of the invention, by a method of detecting an ignition voltage signal generated by a pencil ignition system, whereby the electromagnetic emission by the pencil ignition system is detected capacitively and analyzed to yield an ignition voltage signal. This has an advantage that the signal is picked up in a non-contact manner and without intervention into the design of the pencil ignition system. The electromagnetic emission by an ignition coil in the pencil ignition system is advantageously detected capacitively and analyzed. This has the advantage that the ignition voltage signal is detected exactly at the location that is the source of the ignition voltage for a cylinder. It is particularly advantageous that the electromagnetic emission is detected radially around the ignition coil. This makes it possible to detect a measurement signal having a high amplitude and a high quality, i.e., a signal with the least possible distortion due to outside influences.

An advantageous pencil ignition system designed according to the invention has a pencil-like arrangement of a spark plug mounted on a neck piece having an integrated ignition coil, and a measurement arrangement for an ignition voltage signal having a pickup which is made of an electrically conducting material and which at least partially surrounds the ignition coil. Since the pickup surrounds the ignition coil at least partially, the electromagnetic radiation emitted in all spatial directions when an ignition pulse is generated can be detected to a great extent and used to form the desired ignition voltage signal.

If the pencil ignition system also has a head part at least having a connector plug for the control signal lines and power supply lines, it is particularly advantageous if a measurement signal line for the desired ignition voltage signal leads from the pickup to the connector plug on the head part. The measured ignition voltage signal may then be relayed without additional cabling, e.g. to an electronic analyzer, via e.g. a cable harness and/or a signal bus. Thus, the electrical connection can be implemented by contacting a mating plug to the connector plug, and can be brought all the way to the pencil ignition system itself.

In a first embodiment, the pickup is configured to be placed over the neck piece of the pencil ignition system. This has the advantage that the pickup of the measurement arrangement can easily be retrofitted as an exterior component. In another embodiment, the pickup is integrated directly into the neck piece. It is then preferably arranged on the inside of the jacket of the neck piece and directly surrounds the ignition coil. Although this configuration requires structural adaptation of the pencil ignition system, it renders possible a high-quality ignition voltage signal that is particularly free of interference.

The pickup is advantageously bent in a cylindrical shape and is made of an insulated copper foil. It is preferably insulated by means of a plastic coating. This thus forms a cylindrical insulated capacitor plate. The cylinder may be closed like a shell and may thus have a uniform conductivity in all radial spatial directions. In another embodiment, it is also readily possible for an insulated copper plate which is originally planar to be bent into a cylindrical shape and then to have a slight axial gap in the jacket.

A pencil ignition system according to the invention may be used advantageously for a cylinder in an internal combustion engine.

In another embodiment of the inventive method, it is in principle also possible to mount the pickup, which is advantageously cylindrical, of the measurement arrangement in a stationary mount in the interior of the bore of an engine block, this bore being intended to accommodate the pencil ignition system. When the pencil ignition system is installed, it is passed through the pickup, which is already installed, such that it then surrounds the ignition coil of the pencil ignition system, preferably directly.

### BRIEF DESCRIPTION OF THE DRAWINGS

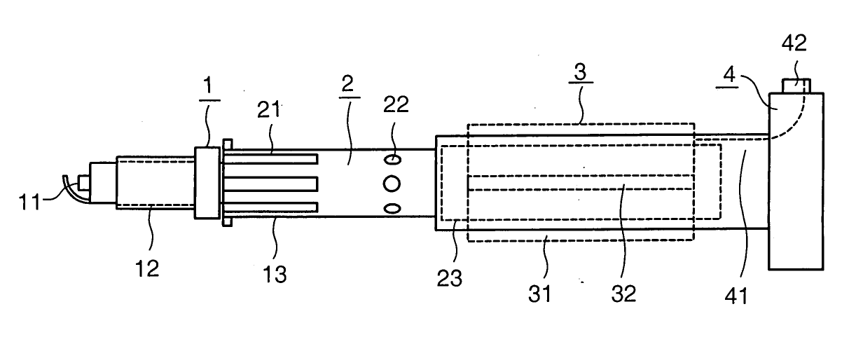

The invention is explained in greater detail below on the basis of an exemplary embodiment as illustrated in FIG. 1.

### DETAILED DESCRIPTION OF THE PREFERRED EMBODIMENTS

FIG. 1 shows a pencil ignition system having a spark plug 1 which is situated at the left end of the configuration in FIG. 1 and has, inter alia, an ignition electrode 11, a screw-in thread 12 for mounting the entire configuration in an engine block and a spark plug neck 13 having an insulator and a voltage contact. The spark plug neck 13 is inserted into a plug part 2 which is used for mechanical accommodation and electric contacting of the spark plug 1. The ceramic insulator on the spark plug neck 13 is held by clamping means 21. Electrical contact means 22 are provided directly at the transition point between the spark plug 1 and an ignition coil 23.

The ignition coil 23 is integrated into a sleeve-shaped neck piece 3, which is shown with dotted lines, in the embodiment of FIG. 1. According to an advantageous embodiment of this invention, the pickup 31 for the ignition voltage signal is designed as a curved cylindrical insulated copper foil. According to this embodiment, the pickup 31 has a slit formed by insulated abutting surfaces 32 resulting from the foil design, and is, as such, configured to be pushed from the outside over the neck piece 3. FIG. 1 shows the pickup 31 with dotted lines, as well, for purposes of better illustration. In another embodiment (not shown in FIG. 1), the pickup may also be inserted into a hollow space between the ignition coil 23 and the inside surface of the neck piece 3 and may thus be integrated completely into the pencil ignition system.

The embodiment of an inventive pencil ignition system shown in FIG. 1 has an additional head part 4, on the right end in the figure. An electronic triggering device for the ignition coil may be integrated into this head part 4. In addition, the head part 4 advantageously serves as a carrier for a connector plug 42, over which control signals, in particular ignition signals, and power supply for the ignition coil 23 can be sent to the pencil ignition system.

According to another embodiment of this invention, shown in FIG. 1, a measurement signal line 41 can be provided in the interior of the pencil ignition system from the pickup 31 to the connecting plug 42 on the head part 4. This has the advantage that no exterior cabling is necessary for the additional measurement configuration, and the ignition voltage signal supplied by the pickup 31 can be relayed via the plug connector 42 and corresponding mating plugs.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. A method of detecting an ignition voltage signal generated by a pencil ignition system, comprising:
detecting electromagnetic radiation emitted by the pencil ignition system capacitively; and
analyzing the detected electromagnetic radiation to yield an ignition voltage signal.

2. The method as claimed in claim 1, wherein the electromagnetic radiation detected capacitively and analyzed is emitted by an ignition coil in the pencil ignition system.

3. The method as claimed in claim 2, wherein the electromagnetic radiation emitted is detected radially around the ignition coil.

4. The method as claimed in claim 1, further comprising igniting a spark plug of a cylinder in a combustion engine with the pencil ignition system.

5. A pencil ignition system, comprising
a) a pencil-shaped configuration including a spark plug mounted on a neck piece having an integrated ignition coil; and
b) a measurement arrangement for an ignition voltage signal having a pickup which at least partially surrounds the ignition coil and is made of an electrically conducting material.

6. The pencil ignition system as claimed in claim 5, further comprising:
a) a head part including at least one connector plug for at least one of a control signal line and a power supply line, and
b) a measurement signal line extending between the pickup and the connector plug on the head part.

7. The pencil ignition system as claimed in claim 5, wherein the pickup is arranged over the neck piece.

8. The pencil ignition system as claimed in claim 5, wherein the pickup is integrated into the neck piece.

9. The pencil ignition system as claimed in claim 5, wherein the pickup is curved in a cylindrical shape.

10. The pencil ignition system as claimed in claim 5, wherein the pickup comprises an insulated copper foil.
